(19) United States
(12) Patent Application Publication
(10) Pub. No.: US 2026/0019303 A1
(43) Pub. Date: Jan. 15, 2026

(54) Novel Network Infrastructure and Connectivity for Participating Edge Devices

(71) Applicants: Richard Schmitt, Lakeway, TX (US); Surya Kumar Kovvali, Carlisle, MA (US)

(72) Inventors: Richard Schmitt, Lakeway, TX (US); Surya Kumar Kovvali, Carlisle, MA (US)

(21) Appl. No.: 18/770,723

(22) Filed: Jul. 12, 2024

(51) Int. Cl. H04L 12/46; G06F 9/50; H04L 41/40; H04W 28/02

(52) U.S. Cl. CPC H04L 12/4641; G06F 9/5072; H04L 41/40; H04W 28/0289

(57) ABSTRACT

A novel approach for configuring network infrastructure and connectivity that allows custom, adaptive, and cooperative interplay between all provisioned members is identified. It introduces the term “Vapornet” that represents a network cloud that extends to edge devices that may be dynamically added, removed, and configured to provide services to participants. Every Vapornet user has a distinct view of services provided by the traditional cloud along with mobile and other edge devices via his own name space. Service entities may be in the network infrastructure, or distributed within multiple edge devices, networks, or Internet. Additionally, it identifies instantiating and/or activating physical or virtual functions opportunistically in transit networks and user devices for improving service availability and quality of experience. It identifies instantiating server agents in client devices that facilitate connectivity and resource access functions in a partitioned network when connectivity to original servers is lost.

### CROSS-REFERENCE TO RELATED APPLICATIONS

This application claims priority of U.S. Provisional Patent Application Ser. No. 63/628,396 filed on Jul. 17, 2023, the disclosures of which are incorporated herein by reference in their entirety.

### FIELD OF THE INVENTION

The present invention relates to the field of cloud networking, a kind of information technology (IT) infrastructure in which some or all of an organization's networking resources are hosted in the cloud.

### PRIOR ART

1. J. Eman, V. Gopalakrishan, R. Jana, K. K. Ramakrishnan and AT&T Labs, “Towards a SPDY'ier Mobile Web?,” in Proceedings of the Ninth ACM Conference on Emerging Network Experiments and Technologies, 2013.
2. S. K. Kovvali, R. Raghavan and K. Ramakrishnan, “Content Caching in the Radio Access Network”. U.S. Pat. No. 8,111,630 B2, 7 Feb. 2012.
3. R. Hamilton, J. Iyengar, I. Swett and A. Wilk, QUIC: A UDP-Based Secure and Reliable Transport for HTTP/2, 2015.
4. S. K. Kovvali and et. al., “Multi-Interface Multi-Layer State-full Load Balancer for RAN-Analytics Deployments in Multi-Chassis, Cloud, and Virtual Server Environments”. patent Ser. No. ______, 30 Oct. 2014.
5. P. Rodriguez and V. Fridman, “Performance of PEPs in Cellular Wireless Networks,” in Workshop on Web Content Caching and Distribution, Cambridge, UK, September 2003.

### BACKGROUND OF THE INVENTION

A typical computing cloud is a collection of servers, storage, databases, networking, and other entities provided to users over the Internet. FIG. 1 depicts a sample general cloud in which a User 101 accesses resources 102 in the cloud through Firewall 103 after authentication & attestation 104.

There are generally three classes of clouds: Public Cloud, Private Cloud, and Hybrid Cloud. This invention defines a new class of cloud called a “Vapornet”.

A public cloud refers to a type of cloud computing service that provides computing resources, such as virtual machines, storage, and applications that share physical resources over the internet to the public or small, medium, or large enterprises. It is called a “public” cloud because the underlying infrastructure is owned and managed by a third-party cloud service provider, which makes these resources available to multiple users on a shared basis.

FIG. 2 depicts a public cloud. What it shows is multiple entities 201 access services within the internet. The services are generally accessed in one direction, that is, from external entities into the public cloud 202.

A private cloud, also known as an internal or corporate cloud, refers to a cloud computing environment that is exclusively dedicated to a single organization (a large enterprise). Unlike a public cloud, a private cloud infrastructure is not shared with other organizations or the general public. It is designed to meet the specific needs and requirements of the organization that owns and manages it. Like a public cloud, a private cloud provides virtual resources over common physical networks, but resources are shared only within the organization. For example, different departments, and in some cases, valued partners can access services within the cloud, but not other external entities.

FIG. 3 depicts a general private cloud. It generally appears similar to a public cloud, but it is dedicated to a single entity. The figure shows entity 201 that accesses private services within internet location 302.

A hybrid cloud refers to a computing environment that combines both private and public cloud infrastructures, allowing organizations to leverage the benefits of both models. In a hybrid cloud setup, the private and public clouds are interconnected and share data and applications seamlessly.

FIG. 4 depicts a hybrid cloud which combines public and private cloud components. It essentially shows the private cloud extended with a network of services local to an entity. Users 101 or entities 201 access private services 302 in addition to services hosted within public clouds 202. Users 101 can access services within the entity 201 or from public 202 and private 302 clouds. Although hybrid clouds can aggregate services from multiple public or private clouds, they are still targeted at enterprises. They do not cover the services provided by edge devices or edge networks. This implies that cloud services will not be available when internet connectivity is lost. Additionally, the connectivity, access control, security protections, storage, and compute services are managed by the cloud service provider. While transit network connections are protected by methods such as TLS, HTTPS, and cloud security with encryption, TLS/HTTPS connections terminate in the corresponding servers, and the cloud security is specific to the applications. Any security compromises or malware in the corresponding cloud provider could affect other users and organizations. Additionally, service costs for storage, compute, network, or application services could continuously increase with usage time, capacity, and processing needs. Thus, the users or enterprises lose control of the environments they are using; for example, in a business down-turn, when revenue decreases, it would be difficult for an enterprise to substantially cut down on previously used storage, compute, and other resources while at the same time satisfy the remaining customers.

As the computing power, memory, and storage capacities in edge devices such as Desktops, Laptops, tablets, smart phones, servers, USB drives is increasing, user content is increasing over these edge devices. While many cloud providers provide client applications in these edge devices to access cloud services, the edge devices themselves are not part of the cloud, in the sense that users cannot access and share resources seamlessly from one device to another or with cloud. Additionally, when the internet connectivity is lost and could not access cloud service, while user can access resources in each device locally, they could not seamlessly view and use all the resources in the edge devices with single global view. Service costs for Cloud storage, and service use continuously keep increasing. While application developers, small and medium enterprises have their own compute, storage & network devices, and may need denser cloud environments rarely, they could not mix the two environments with ease. Additionally, while cloud services provide security protection, any security compromise and vulnerabilities affect the number of users that share the environment. It would be nice if the users could mix the edge environment with the cloud service environments, compute and store data in the plurality of local edge environments and use cloud services selectively when needed. That significantly reduces cloud service costs.

The “Vapornet” identified in the current invention defines methods to interconnect edge and cloud environments and share resources seamlessly using “directory service” and global name space that framework maps transparently to physical locations. Internet and networking infrastructure uses network devices that perform functions such as L2/L3 Switching, L2 Bridging, Routing, Database Servers, Application servers such as mail servers, Application proxies etc. Communication service providers offer hosting such devices in their managed network locations. Such functions may be performed by physical hardware or may be run over plurality of virtual networks (Cloud, SDN, VMs etc.) on multi-service platforms that share underlying hardware and provide the services for multiple enterprises, and users. VNFs over virtual networks facilitate flexible migration and growth by expanding underlying resources based on service demand. In prior art methods VNFs are deployed in Cloud, Internet, enterprise locations where dense hardware is deployed. User devices (such as mobile devices, laptops etc.,) utilize those services via plurality of networks that connect to the VNFs. While the underlying resources in the cloud for a specific VNF may expand, VNF itself is static. As virtual networking and the power of the network, compute & storage devices are increasing, and network functions could be performed over virtual devices, ability to instantiate or activate VNFs dynamically significantly improves service availability, decreases round trip times and improves QOE. For example, e-mail services for an enterprise require a mail server. Enterprise locations used to have mail servers. As cloud services over shared hardware grew, enterprises migrated to cloud hosted mail server to reduce installation, operational and upgrade costs, and connect to the cloud hosted servers via internet. However, if the connection to the internet is lost in the enterprise location, even the users in the same location could not exchange email. It would be nice if the users in the same building or location or local network could communicate even when the connection to remote cloud/internet server is lost. Similarly, if the connection to the mail server hosted in a remote city is lost, mail exchange in the local networks continues to work. The current invention teaches methods to instantiate and/or activate such functions (for example mail server proxy) opportunistically. The methods of instantiating and activating such network functions is termed, “Adaptive Dynamic Network Functions (ADNF)”, in the current invention.

Many users use multiple high-capacity smart devices (mobile phones, tablets, laptops, desktops, servers etc.). Typical user in some regions carry multiple smart phones (work, personal, local/foreign phone etc.). With rapidly growing technological advancements, the compute power, memory storage capacities, camera and screen resolutions, wireless mobile & local network throughput capacities are continuously increasing. Many devices, cloud and application service providers offer cloud storage to backup, share (family sharing) content such as photos, videos, social media content etc. User devices use client applications that communicate with cloud/internet servers, and any backup or sharing goes through the servers per the client-server model. If the connection to the internet server is lost the devices with the user or user's family do not communicate. Users selectively use applications such as “Air Drop” over local network (WIFI, Bluetooth etc.), USB ports etc. The connectivity and resource access such methods provide is not seamless like connecting with internet application server. Also, as the throughput to internet server decreases due to network congestion or wireless coverage, uploading significant data volumes (for example, user's mobile phone storage is full, taking HD photos requires clearing storage, the uploads take significant time or users have to reduce the resolution. Also, as the cloud storage space increases, users need to keep upgrading with additional costs. The user may have nearby laptop or desktop with high storage capacities, and backing up or off-loading takes significant effort. It would be nice if the user device automatically uploads to nearby high-capacity devices such as laptop or desktop and makes space for new content. To this goal the current invention identifies “Server Agents”, that each client device contains in addition to the client application and the server (either internet server or a server in one of the user devices) coordinates server agents. When the connectivity to server is lost one of the server agents could temporarily act as server and provide services to the clients in the partial network.

A number of users and small & medium enterprises use removable devices such as flash drives, SSD & Hard drives to their computing and other devices such as smart phones, tablets that may have storage, computing power and network connectivity. Such devices may have security vulnerabilities or users that have login privileges to the systems may copy from or to the device. Such a user could be a laid off employee or a disgruntled employee political campaigner. It is desirable when a removable device is plugged into a USB or other interface, the device carries what authentication/privileges are needed in the system that it is connecting to, what authorization, access privileges are required (for example multi-factor authentication, digital certificates etc.) from users that access the device. Using multi-factor authentication methods such as OTP (One time password) via prior established email address, telephone number, user credentials such as place of birth, high school etc., when user's login or access a system are well known in the prior art. They are for user login into the system, resource access (such as specific department's directories or networks), and not for cross validation for removable/pluggable devices. It would be nice when a user plugs in a removable device cross validation (system with device & device with the system) is performed and such plug-in, device/file-system mount is performed before the device is allowed to be part of users' network & system environment such as Vapornet Edge network and when the user access Read, Write, or Modify the device content. While users may use encryption and password protection, with ever increasing computing power, such methods do not always provide security. While users or organization may use encryption via passwords, additional security & trust assurance methods during device insertion/removable significantly enhances security. The current invention identifies using the security validation methods for insertion/removal of such devices. If the underlying virtual framework such as Vapornet, or a secure container that contains user/enterprise orchestrated validation methods performs the validation using the methods and attributed embedded in the device, it significantly increases security and privacy protection.

Additionally, a storage device from a laptop or desktop could be removed and device contents accessed by connecting to different system and accessed with login & access privileges of the new system the device is connected to, and not the access privileges of the original system. In the prior-art methods security & resource access methods are associated with the system, and not per system component such as storage device. Thus, a laptop that belongs to a high security enterprise or user can be stolen, and its storage device removed and connected to a different system with zero or lower security enforcement. What is stored on the device may be encrypted with passwords; but with ever increasing computing power, encrypted files may be de-encrypted, for example, by serially trying each possibly combination from 1 to N characters/symbols etc., and determining which combination gives most recognizable words in the language, and additional AI methods. If each device and filesystems within contain information on security validation required, what in the system need to be validated when the device is connected to the system, and what in the device need to be validated while any portion of the device contents are made available to the system, it significantly increases security and privacy protection. The methods of validation may include Digital Certificates, Multi-factor authentication, user or organization attributes, passwords etc. The current invention identifies methods to facilitate such validation.

### SUMMARY OF THE INVENTION

A novel approach to configure network infrastructure and connectivity that allows for custom, adaptive, and cooperative interplay between all provisioned members is identified. It introduces the term “Vapornet” which represents the underlying network connectivity and end points envisioned in the current patent application. A Vapornet is a network cloud that extends to edge devices where edge devices are dynamically added, removed, and configured and fully participate in providing services for the network participants. Every user of the Vapornet has a distinct view of services provided by the traditional cloud plus the edge devices including mobile devices and has their own namespace. Service entities may exist within the network infrastructure, may be distributed onto multiple edge devices or edge networks, or may exist within the Internet Backbone.

The Vapornet provides for a virtual namespace of resources that can be mapped to physical resources. The location of the physical resources is unknown to the user. Physical resources are dynamically added, removed, and reconfigured within the Vapornet continually. Vapornet also provides compute services that can migrate around the underlying virtual network between edge devices, intermediate nodes, and traditional network service nodes.

An additional area of the current invention is that the network connection established between applications running on edge devices and the resources they wish to interact with are instantiated with virtual network/service/application-aware intermediaries based on the resource usage of the application. The invention proposes that when mobile applications are initiated by users, they propagate resource needs toward the network. Transit network devices that support the current invention methods will steer the connection requests to the appropriate network control points, servers, transit CDNs, or cloud service points and will modify the network paths to the client based on user membership level, transit network availability, service provider relationships, and application service expectations.

The invention identifies instantiating or opportunistically activating virtual network functions to facilitate or enhance services in transit network elements such as switches, routers, storage servers, etc. in operator networks by the application service providers. The methods facilitate offering value-added services for CSPs. Additionally, the invention identifies dynamically and opportunistically creating or activating server agents (or proxies) that perform content caching, forwarding, hair-pinning, uplink/downlink storage buffering, stream replication, etc., functions in the transit network elements or in an elected client node. The identified methods facilitate increasing service availability of cloud-based services (such as Office/Exchange/Excel etc.), in local network segments when connectivity to the cloud server is disrupted. It teaches methods by which transit nodes that support the identified methods propagate the capabilities to the target cloud server so that the server could dynamically set up or activate a controlled set of features in the network elements.

The term “Vapornet” identified in the current invention teaches 3 key concepts below:

Content & Resource access and sharing across a plurality of user devices. These devices are managed by the user. These devices are made available to the plurality of network environments that they have access to by defining a virtual namespace across all the devices and providing a hierarchy of directory services that maintains, syncs up, and makes components available to the underlying devices. The devices could cache and interconnect with other devices for using service from other devices depending on the local network they are in at a specific time. The set of user devices includes physical devices such as smart-watch, smart-phone, tablets, laptops, Desktops, and virtual cloud devices (drop-box, AWS compute/storage, application server). It is important to note that user devices could access and share services in the local network they are in even if they are not connected to the internet or cloud. They cannot connect to the remote device, for example, cloud hosted virtual device or work server, when the network connectivity (internet etc.), to that server is lost. The virtual namespace methods identified facilitate accessing and referring to the resource, such as a photo library in his current environment (no internet connection) by the same name he is using when he has full connectivity.

Adaptive Dynamic Networking Function (ADNF) refers to dynamically & opportunistically installing or activating virtual network functions (VNFs) in the end devices or transit network elements to facilitate additional services and/or to reduce round trip times, increase throughput, etc., for user and service quality of experience. VNFs facilitate edge services, such as content caching, and hair-pinning in edge networks. Transit network service providers such as CSPs, Access Network Providers, and Wireless Network Service providers could facilitate the deployment of the VNFs, for increased revenues to offset the loss of revenues from hosting services. For example, such a VNF could function as a CDN Proxy with content prefetching/caching that works in coordination with origin server, and function when traffic volume at the geographical area is high, for example during a stadium event. The CSPs could charge by time and usage basis for such VNF use.

ADNF above includes turning on or activating certain network functions in edge devices to facilitate increased network connectivity, and connectivity to the internet as needed. For example, in a home environment that uses a WIFI access point that uses a wireline service, such as cable, FIOS, etc., as an uplink to the internet, when the connectivity to the internet is lost, all the devices connect to WIFI-AP but cannot connect to the internet. The user may have a smartphone with WI-FI and cellular data service with WI-FI-Hotspot capability. Automatically turning on WI-FI Hotspot in the mobile phone and configuring the home WIFI-AP to use mobile hot-spot as an uplink to the internet or facilitating all devices at home to switch to WI-FI Hotspot will substantially increase service availability. The method of such migration to mobile hot-spot includes but is not limited to, turning off the WI-FI network (specific SSID) that has lost uplink connectivity to the internet, and turning on the WI-FI Hotspot function in the mobile device.

A network cloud usually is instantiated with devices that are within the network core and accessed by devices from the edge. Typically, it does not include the devices within the Internet Backbone that provide connectivity from the edge into the cloud. Additionally, network protocols and deployments have been defined with the goal that computing systems connect to other computing systems over wireline networks, and if connectivity is maintained continuously from the client to the network/default router, etc., the network will always be ready when the user invokes an application. Most of the heavy applications that use significant CPU cycles, storage, etc., are predominantly near the enterprise location or within the internet/cloud network.

When a user starts a browser application in the client such as using a laptop or Smart-Phone, its service needs are unknown since the need defined by the website that the user accesses and the content the user will use are unknown. Thus, if a user accesses a Yahoo website, and reads top-level pages, the transit resource needs are different from when the user starts a live video download. Web applications use the HTTP protocol differently with differing resource needs. HTTP can service a simple Yahoo page, and it can service an intensive video playback. While the client device knows the activated mobile app and the specific user's access pattern it is not propagated to the network. The user's application usage profile, how long he normally uses the application before switching to the next site or application, or how frequently he hops from one app to another is trackable in the user's device. Most users select an application and stay with an application for a significant time depending on the application type.

A method by which the service needs that are expected by the user device, the type of application and what resources, connections, bandwidth it normally uses, and the location (home, office, traveling, etc.) can provide hints to the transit devices and network operators to dynamically adapt the transit network to meet the service demand. The adaptive networking identified in the current invention teaches such methods.

Considering an email service or a video conference, when three clients of a video conference are in the same local network (for example same city), the current semantics require-they connect to an internet server that serves as a relay, and if the relay is down, the clients in the vicinity can't connect to each other. With evolving cloud deployments, a global server could use the cloud service to logically distribute itself to cloud data centers. While the cloud technology brings servers closer to the delivery points, it still requires cloud data centers and relationships with cloud service providers. Such a technology does not optimally facilitate ad hoc application-level connectivity between multiple devices of the same user, or between different users of the same family or organization in the network segments nor does it facilitate the use of application services hosted in the cloud when a user's internet connectivity is lost or congested.

Cloud & Internet-based storage and services provide methods for using servers and storing application data for a plurality of user devices without requiring & managing dedicated hardware by users or enterprises. Examples include Dropbox, iCloud, AWS, Google Cloud, Office365, etc., which are all hosted in the cloud. They relieve enterprises of IT management for hosting and maintaining such services in local enterprise data centers and facilitate leasing/renting such services from Cloud and Storage Service providers at a lower cost. However, such service use requires internet connectivity to the corresponding cloud servers. When internet connectivity is poor or interrupted due to access network (for example cable or wireless mobile network) or transit network congestion or service provider's monetization/priority controls, or flash-mob conditions during events, such internet connectivity is lost or severely degraded. This makes services that are dependent on internet connectivity unusable. Some applications such as Exchange and Mail maintain caches in clients so that users could access their mail previously downloaded when the connection to a mail server is lost. In some countries, such as India, network degradation and power outages in the internet service chain are frequent. While internet connectivity is down, network connectivity in local networks is still available. For example, WIFI, Ethernet, 3G/4G/5G connectivity between a set of related users may still be available. However, they can't use such services in a local network without communicating with central servers, or CDNs that have relationships with the websites. For example, if a mail server for an enterprise location is hosted by a cloud server, when internet connectivity is lost, two users within the enterprise, in the same location, or within the same house cannot send mail to each other even though they have network connectivity to each other. It would be nice if a set of users in a group that have a need to communicate or use shared services could do so in local environments even if internet connectivity or central/cloud-hosted server connectivity is lost. This requires the underlying methods to sync up with central servers and provide corresponding services in a transparent fashion. The current invention identifies an opportunistic server agent that is controlled and managed by the Cloud and Internet Server and acts as a coordinator in a local network segment, such as an enterprise network. The server agent assumes the responsibility of a real server when the connectivity to the real server is lost so that clients in the same local network can connect to each other in the event of loss of connectivity to the real server. It is important to note that such a server agent may not be a separate independent node but could be within transit network or with in the plurality of client devices that have sufficient resources (storage, memory, CPU, network, and power); the plurality of devices that have connectivity can elect or assume the responsibility based on weights assigned by the server or management entity.

The server agent could be instantiated in a transit network element or already present but dormant, or it is dormant in each client node. The nodes may use an election algorithm to select the role of an agent. The elected agent in the client device performs proxy, storing, forwarding, and hairpin functions (connection between the clients in local segmented network). Additionally, it periodically attempts to connect to the real server and attempts to sync up. It could also perform replication functions such as distributing a mail message that has multiple clients in the same network segments.

An additional embodiment of the current invention is installing security assurance & validation methods and the associated attributes such as contact information and other attributes such as department/user contact information, user information (address, place of birth etc.) in removable other storage devices for validating the system and the device when the device is connected to the system. The methods facilitate security and trust assurance per the device contained methods and attributes when it is inserted and becomes part of a computing system and its file system, and contents are allowed to be accessed by any user of the connected system.

### BRIEF DESCRIPTION OF DRAWINGS

For a better understanding of the present disclosure, reference is made to the accompanying drawings, in which like elements are referenced with like numerals, and in which:

FIG. 1 depicts a typical generic “cloud”. In it, a user 101, accesses a network location which hosts a collection of services 102. The physical location of the services is unknown to the user but are hosted in the cloud under the control of the cloud provider.

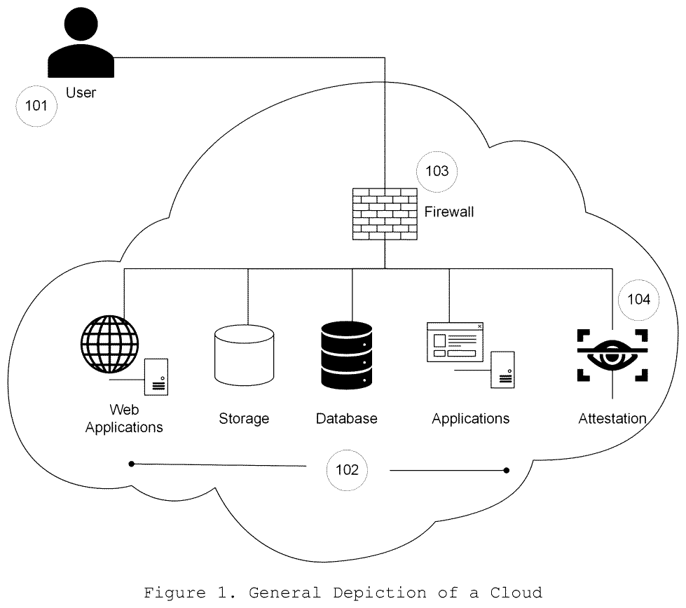

FIG. 2 depicts a “public cloud”. In it, multiple users, or entities 201, access an internet location 202 that provide services.

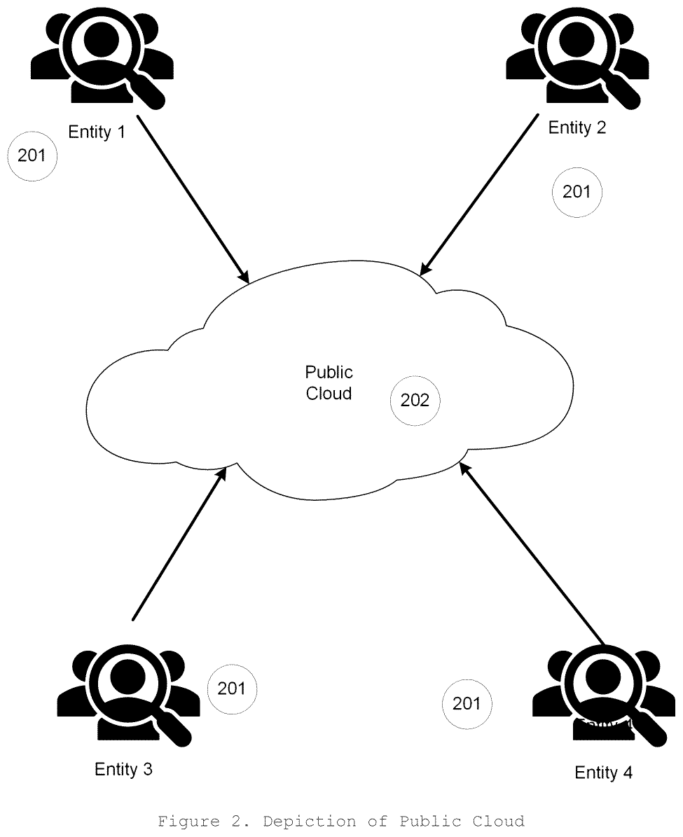

FIG. 3 depicts a “private cloud”. It is similar to a public cloud but is restricted to a single entity 201 that accesses private services within an internet location 302.

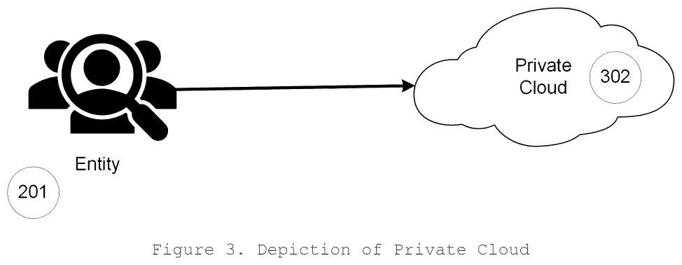

FIG. 4 depicts a “hybrid cloud”. This combines public and private cloud components. In it, the users 101 or entities 201 access private services 302 in addition to services hosted within public clouds 202.

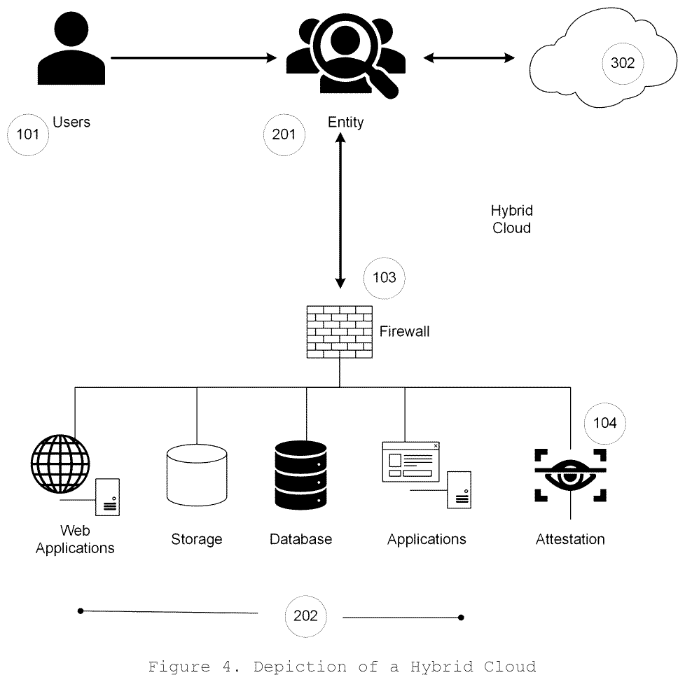

FIG. 5 depicts a “Vapornet Cloud”. This type of cloud still provides services to the users 101 or entities 201 but in addition to access to the public services 202, the entities can access a new class of services 501 whose locations are mapped for the entities through a cloud-based directory service 502. Since these services are hosted outside of a public cloud, access to them is secured through a virtual access point 503.

FIG. 6 depicts a generic end-to-end network connection from an “Evolved Node B” 601 (eNB, a form of cellular base station in an LTE network) to a service hosted within the internet cloud 501. Network infrastructure components that can host the ADNF functions are shown as 602.

FIG. 7 depicts the control flow of user subscription and service activation within a Vapornet Cloud. A user 101, subscribes to the service during which the users access 701 and offered resources 702 are provisioned 703 for Vapornet. The user authenticates 704 against the user namespace 701 and is provided a view obtained from the resource namespace 702. This view provides a mapping to the virtual resource 705 which is further mapped through the directory service 502 through which the requested service can be activated 706.

FIG. 8 depicts a Simple Vapornet Virtual View of file services provided to a user. The Vapornet file services are mapped into a namespace 801. A collection of file services 802 are mapped relative to the Vapornet namespace.

FIG. 9 depicts the physical structure of file view that was shown in FIG. 8. The collection of file services 802 are mapped through the Vapornet Directory service 502. The mapping results in a URL to various physical devices 501 which host the file services 901.

FIG. 10 depicts how hair-pinning that provides service protection may be deployed in local network. Users 1001 wish to access services 1002. For some reason, the communications path 1003, to the service become unavailable. With ADNF, service agents 1004 are deployed at a location closer to the user. Hair-pinning 1005 implemented in a router local to the user intercepts the communications and directs the traffic to the service agents.

### DETAILED DESCRIPTION OF THE INVENTION

This invention defines a new class of network cloud called a “Vapornet”. A Vapornet is like a hybrid cloud, but rather than being targeted at enterprises, it is targeted at consumers and small businesses and services on the edge devices or networks can be shared with other users of the cloud. It targets the network edge, including mobile devices, and allows the interoperability of services and content between mobile phones, laptops, desktops, and server computers.

A Vapornet utilizes core cloud or backbone services as a directory provider rather than a traditional storage and service provider. In a typical network cloud, the location of services (a web server, a database server, a file server) is well known and those services are hosted within the cloud and generally available to edge devices and users via client applications such as web-browser, database client etc. With the Vapornet, these services may be hosted by the edge devices themselves and made available to other edge devices or users on demand. The cloud core provides the translation between a virtual services location and the physical locations that may be user edge devices. For example, a cloud service may use user's edge compute & storage resources at multiple locations and the mapping between virtual name space & physical name space provided by the cloud. The content has a physical location and representation. The mapping of the virtual location to a physical location within the Vapornet is the subject of this invention. The representation is generally specific to the application and may either be opaque to the Vapornet, or in some cases may be visible and translated by the Vapornet. For example, a mobile device may have a mail application, a WhatsApp application etc., and each application stores content in the device in their own format. Vapornet may store the content transparently or may export or translate the content and store it so that it may be usable by other applications.

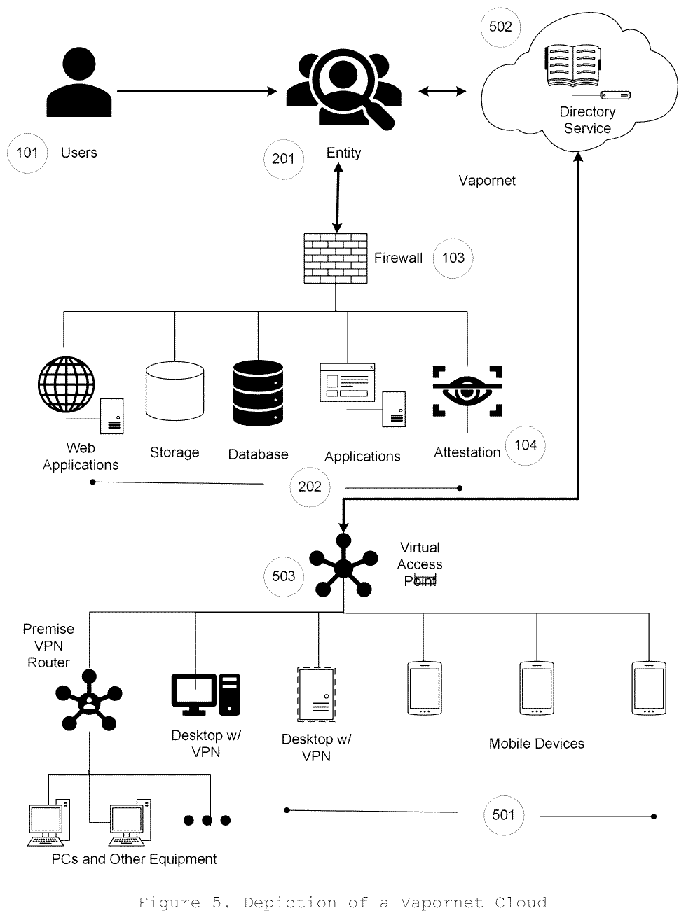

A sample Vapornet is depicted in FIG. 5. The figure shows the basic elements of a Hybrid Cloud, with the addition of a directory service 502 hosted within the Vapornet, and an extension of the cloud that provides interconnection to various edge devices and on-premises networks. It's important to note that resources and services contained in this Vapornet exist within a virtual namespace. That is access to the resources or services is identified with a virtual URL and translated to a physical location. This translation is performed by the directory service 502 within the cloud. This implies that physical resources can move around the global network. This type of cloud still provides services to the users 101 or entities 201 but in addition to access to the public cloud services 202, the entities can access a new class of services 501 whose locations are mapped for the entities through a cloud-based directory service 502. Since these services are hosted outside of a public cloud, access to them is secured through a virtual access point 503.

Services need not be hosted within the cloud network infrastructure but rather can remain on an edge device where it is most available. This is one of the key concepts of the current invention.

A typical cloud provides various services. These services include:
Infrastructure as a Service (IaaS)
Platform as a Service (PaaS)
Software as a Service (Saas)
Function as a Service (FaaS)

The Vapornet is targeted at the SaaS and FaaS classes of services. Examples of Software as a Service include File Servers, Web Servers, and Database Services. Examples of Function as a Service include Azure Functions and Google Cloud Functions.

Note that in a typical cloud, these services do not utilize the wireless or wireline infrastructure that interconnects devices within the network for delivery of the service. They treat the infrastructure as opaque. The network infrastructure that comprises the path that data must flow between an edge device and the cloud service does not participate in providing any of the services other than as a messenger. Types of network infrastructure devices are routers, modems, switches, firewalls, wireless access points, gateways, and more.

This invention also defines a mechanism by which these network infrastructure devices provide cloud services as virtual functions. By leveraging the infrastructure devices, the services can be brought closer to the edge and can be replicated across the network. This provides a decrease in response time and scalability. This is another of the key concepts of this invention.

The current invention also identifies an “Opportunistic Application Proxy/Server Agent” that facilitates buffering, caching, forwarding, and hair-pinning functions in local network segments when a client cannot communicate with Cloud Server or Internet. We refer to this also as an “Adaptive Dynamic Networking Function” or ADNF. With cloud-based services, such as Mail or Exchange services, when a client cannot establish a connection to a server, clients cannot communicate with each other even if they are in the same network segment (local network). While client caching makes previous mail available in an offline mode, two clients in the same WIFI network that have network connectivity to each other, cannot exchange mail without connecting to the internet Cloud Server. A server agent that is opportunistically created in one of the client devices, or in the transit Network Elements (for example in WIFI Access Point) can support such capabilities while still being under the control of the Cloud Server. This will increase the service availability significantly in environments where connectivity is poor and power interruptions in the end nodes and transit network are frequent. In prior art, Super node in Skype performs client to client data forwarding (hair-pinning) in setwork segments at the edge with only control connections going through the central Skype Server. Unlike a Skype Super Node that performs data forwarding in local network segments and requires connection to the internet server, the Cloud server per the current invention methods directs server agents to cache control information to facilitate connectivity between valid clients which in turn increases service availability significantly.

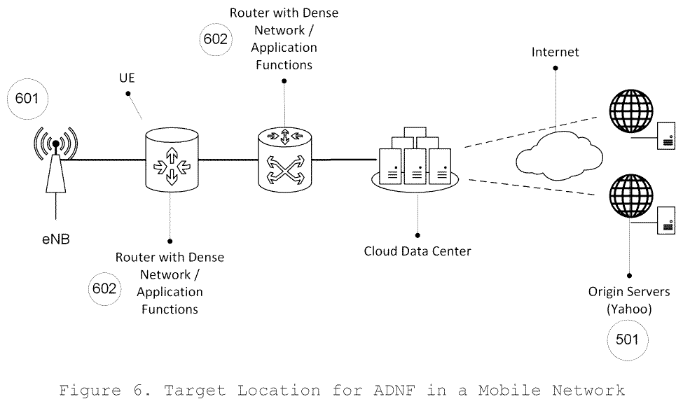

FIG. 6 shows the typical location that ADNF can reside in a typical mobile network. The figure shows an end-to-end network from an “Evolved Node B” 601 (eNB, a form of cellular base station in an LTE network) to a server hosted within the internet cloud 501. Network infrastructure components that can host the ADNF functions are shown as 602.

Such a feature facilitates several value additions:
1. The server agent facilitates hair-pinning between local clients in the same network segment thus reducing latency even when the clients cannot connect to server. The caching in server agents facilitates other client identities without requiring they first connect to the central server that establishes connectivity through a super node at the edge.
2. It facilitates opportunistic edge services—for example, a large video file does not have to be sent to server and then sent back to a client in the same local network.
3. Distribution function at the edge in the local network-server could send one copy to the agent, which sends to multiple clients that are on the same AP.
4. Bulk forwarding, by gathering application content: from multiple clients in a conference/event environment, and thus improving network efficiency.
5. Improved QOE for uploads—for example video upload gets buffered in capable server agent, which then uploads to cloud server.
6. Facilitates enhanced network elements such as WIFI-Access Points with server-like capabilities (thus facilitating edge computing) in an opportunistic way.
7. The server agent functions as a proxy, cache, forwarding and hair-pinning device, with both control and data forwarding functions.
8. Opportunistic Server Agent that is activated & instantiated in compatible network elements in the client-to-server network path. Server to Server Agent Interaction.
9. Locating Server Agents in transit network elements. Monetization for Communication Service Providers (CSP) from enterprise customers and websites for enhanced service.
10. Instantiating server agent in capable end-nodes by electing between multiple clients based on device type, connectivity & BW to the internet, connectivity to the clients, client capabilities, remaining power, connectivity to power source, etc. For example, a laptop or tablet with LTE connectivity & WIFI could become an automatic hot spot for a set of users (for example, same family or enterprise mail list).
11. The election of a server agent in one of the devices based on device capabilities in that segmented network requires propagating device capabilities to the devices. Alternative methods of exchanging such capabilities are, (a) DNS Extensions, (b) Service/Capability advertisement & propagation.
12. Automatically turning a node as a WIFI Client or Access Point (AP) to facilitate edge networking based on application, internet connectivity, contact history, etc.
13. Hair-pin connectivity through the closest Gate Way or Access Point based on source/destination, application type, data volume, etc.
14. Access Network Selection between the server agent & clients based on app type, contact list, mail list, etc.
15. Opportunistic Hub & Spoke connectivity—for example, in a mail transfer from a client via the internet mail server, if 4 recipients are on the same local network, the server agent in AP, buffers mail data in the local cache, and transfers to clients locally while maintaining a single connection to mail server,
16. Server Agent Buffering & Caching uploads from clients reduce the upload time seen by the client and increases the throughput of agent-to-server transfers. Monetization for CSPs from end users via enhanced services.
17. Server Agent facilitating connectivity and transfers in the local network segment when there is no/poor connectivity to the cloud, based on the recent history of client locations (AP, GW)
18. Server Agent maintains a member list of a domain, for example, a plurality users of the same of exchange/office/domain of an organization.
19. Opportunistic prefetching and bundled data fetching in 5G Networks

### Example Embodiments

The Vapornet described in this document potentially has an unlimited number of configurations that provide capabilities unavailable with any of the solutions available today. A few of these configurations are described here.

This section describes the theory of operation using example use cases in, a) file sharing leveraging a Vapornet with a distributed directory service and content storage in both edge devices and the cloud b) performance-enhancing functions in Wireless Mobile Networks, c) Hair-Pinned services in local networks, d) Live Stream Replication & Retransmissions at the Edge, (e) Computing function close to Mobile Edges (f) Opportunistic prefetching and data offload, g) Signaling & service offload in dense locations such as stadiums.

A. File Sharing in Vapornet with Spirit Cloud File Management Service

Spirit Cloud, as identified in the current invention, is an embodiment of Vapornet which provides a cloud-based file management service that manages content in edge devices along with content in the cloud, yet that content can be shared with authorized users anywhere in the cloud.

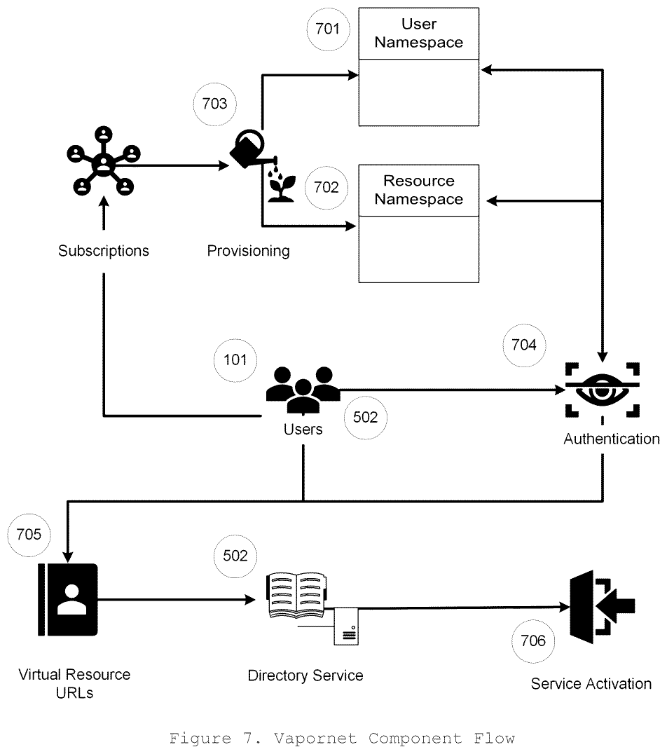

FIG. 7 depicts the control flow of Spirit Cloud using services provided by Vapornet. There are two separate processes: User Subscription and Service Activation on behalf of a user. When a user is subscribed, the user's identity is added to the User Namespace, and any locally owned and shared resources are added to the resource namespace as virtual resources. When a user authenticates, the physical local resources are mapped to the provisioned virtual resources, and the resource namespace is updated. A resource group of virtual resource URLs is also built and provided to the user. When the user attempts to activate a service, i.e., access Vapornet content, the virtual resource URL is mapped to a service through the Vapornet directory service, and the service is activated (i.e., content is acted upon). The figure shows control flow of user subscription and service activation. A user 101, subscribes to the service during which the users access 701 and offered resources 702 are provisioned 703 for Vapornet. The user authenticates 704 against the user namespace 701 and is provided a view obtained from the resource namespace 702. This view provides a mapping to the virtual resource 705 which is further mapped through the directory service 502 through which the requested service can be activated 706.

The components and actions of Spirit Cloud used in this embodiment that will assist in its understanding are described here.

### 1. Authorization Namespace

The Spirit Cloud contains an Authorization Namespace which is a collection of users and groups each with authorizations for various resources and resource groups.

### 2. Resource Namespace

The Spirit Cloud also contains a Resource Namespace which is a collection of resources and resource groups. Each resource is identified by a virtual URL (Uniform Resource Locator) and contains a physical URL and a membership list. At various times during the life of the resource, the physical URL may be undefined. This would indicate that the resource is currently unavailable. Dynamic virtual-to-physical mapping of namespaces is a novel component of Vapornet.

### 3. Provisioning of a User

When a user subscribes to Spirit Cloud, he/she is assigned to one or more groups and provisioned with access to one or more resources and resource groups. At the time of provisioning, or at any time in the future, the user allocates a set of resources and assigns them a virtual URL. The allocation of virtual resources for a user is a novel component of Vapornet.

### 4. Authorization of a User

When a user authenticates with Spirit Cloud, a Resource Namespace is created distinct to that user. The Resource Namespace is built using the resources and resource groups it has been provisioned with. At the time of authentication, the user also identifies which physical resources, identified by a physical URL, it wishes to assign to various resources it has previously allocated. The creation of a distinct resource namespace for the user and the presentation of physical resources at the time of authorization is a novel component of Spirit Cloud.

### 5. Resource Directory Service

At any time while authenticated, a user may access resources using a virtual resource URL. Translation of the virtual URL to a physical URL is performed by the Resource Directory Service. The directory service may detect that a physical URL is not available for a particular resource. This may happen if a resource has been created as part of user provisioning, yet the user is not currently authenticated. Awareness of unmapped virtual resources during lookup is a novel component of Spirit Cloud.

The directory service described here can be replicated and can migrate anywhere within the Vapornet, including cloud core devices, edge devices, and backbone devices as described in ADNF. Replication and mobility of the Directory Service within the Vapornet is a novel component of Spirit Cloud.

### 6. Resource Service

Every physical URL identifies a resource service that exists on some edge or cloud device. Access to the resource is identified with the URL of the resource and the authorization of a user for the service. A resource service must be able to validate the authorization to use the resource for that user in addition to servicing the resource request.

### 7. Accessing a Resource

Any authenticated user within the Spirit Cloud may attempt to access any resource contained within their distinct resource namespace. Access first involves contacting the resource directory service to translate the virtual URL to a physical URL. If a valid physical URL is returned, the user may attempt to access the physical resource by providing its authorization and the full physical URL he or she would like to access. Once access to the resource is granted, the user may then perform any valid operations known by both the user and the resource.

### 8. Spirit Cloud Network Representation

When a user authenticates with Sprit Cloud (aka. The Vapornet), a virtual network of available resources is created. In the case of Spirit Cloud, this network consists of virtual file shares arranged in a flat namespace.

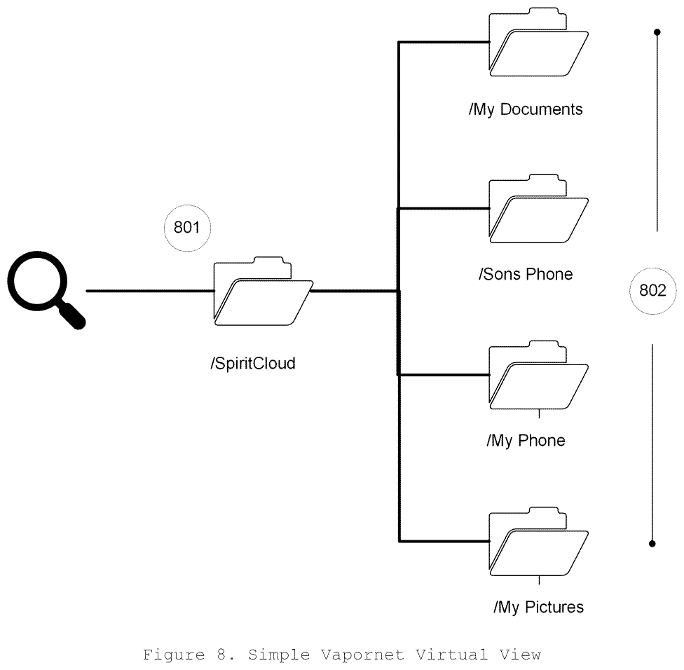

An example network is shown in FIG. 8. In this view, upon logging in, the user sees four subdirectories: “My Documents”, “My Pictures”, “Sons Phone”, and “My Phone”. It doesn't matter if he's logged into Spirit Cloud from his phone, from his Home Computer, from a Work Computer, or from someone else's phone. His network view will be the same. The figure shows a Simple Vapornet Virtual View of file services provided to a user. The Vapornet file services are mapped into a namespace 801. A collection of file services 802 are mapped relative to the Vapornet namespace.

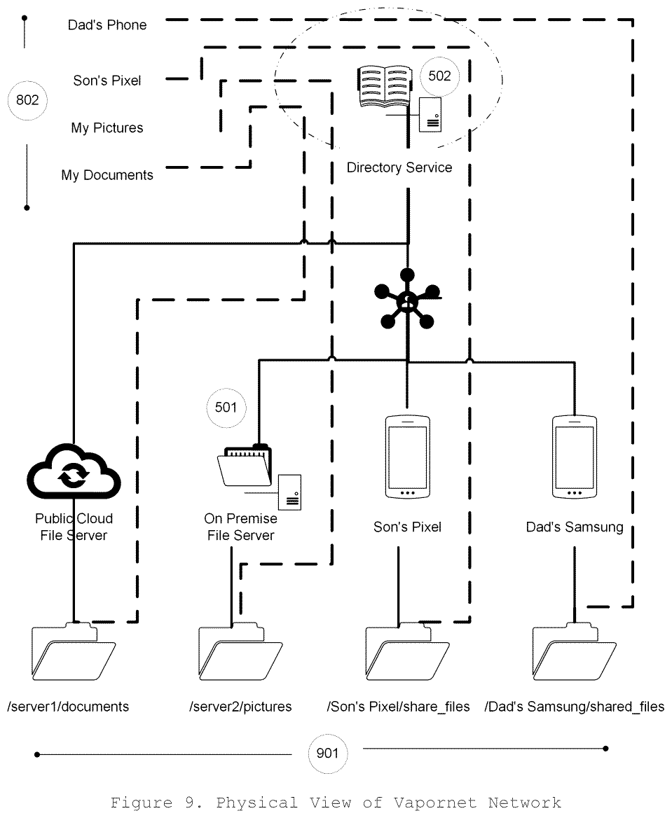

There will be a physical network behind this virtual view that is maintained by the Vapornet Directory Service. The directory service will update the physical network view upon users authenticating and offering new resources, disconnecting, and removing resources, or other maintenance of the core network which may move resources to other physical locations. A sample view after mapping through the directory service may look like FIG. 9. The figure shows the physical structure of file view that was shown in FIG. 8. The collection of file services 802 are mapped through the Vapornet Directory service 502. The mapping results in a URL to various physical devices 501 which host the file services 901. All accesses to the storage resources flow through the cloud-based directory service. “My Documents” are hosted within the Public Cloud on a file server called “server1” and a directory called “Documents. Accesses to “My Pictures are also routed through the directory service, and a VPN to an on-premises file server called “server 2” and a directory called “Pictures. Accesses to Son's Phone go through the directory service and get redirected over a VPN to Son's Phone and a shared directory called “shared_files”. Likewise, accesses to “My Phone” go through the directory service and get redirected through a VPN to “Dad's Samsung” and a shared directory called “shared_files”. The actual location and mapping are specific to the configuration of each individual Vapornet. The flexibility of the configuration is a benefit of this invention, but the configuration itself is outside the scope of this invention.

### B. Performance Enhancing Functions in Wireless Mobile Networks

The benefits of Split-TCP, content caching, and CDNs in improving user QOE by reducing round-trip times is well known. U.S. Pat. No. 8,111,630 B2 teaches methods for deploying such proxies in Radio Access Network (RAN), where the user IP packets are encapsulated in unidirectional GTP-U tunnels. More recently the use of encryption at the HTTP header level (HTTP2) or at the transport level (QUIC) to increase privacy and prevent man-in-the-middle attacks are well known in prior-art. Such encryption complicates the deployment of PEPs both in wireline & wireless networks. If a user request needs to terminate in Origin Server (OS), and Client< >OS transport delay is high, it increases round-trip time and reduces user QOE. To compensate for the increased delay, QUIC, SPDY protocols, reduce the number of round trips by multiplexing multiple flows over single connections (to reduce number of TCP connections), increasing window sizes, and preserving authentication context for minimizing security-related exchanges. While the methods improve end-user throughput in favorable network conditions and improve web page download times, the Client< >OS control loop will still be highly impacting small pages and infrequent accesses.

Additionally, the large control loop makes the applications non-responsive due to buffer buildup in the transit network. In

Wireless networks, the delay and capacity vary due to user mobility, contention, and service prioritization. When the delay/capacity to the user decreases, buffers build up in BS/RNC/eNB that process user packets transparently and does not track transport connections. If the user started off a video and migrates away to a different video, the packets in the pipeline cause head-of-line blocking to the new flow of packets. Thus, reducing Client< >Server control loop, and Content & Content-Aware scheduling maximizes QOE. Thus, with encryption, reducing control loops require bringing CDNs that terminate the client's transport connections closer to the edge of the network. However, CDNs perform optimization functions only on their client's Origin Servers. Thus, SMB websites, and user websites that do not have relationships with a CDN or with a specific CDN in a target market do not get CDN benefits.

The current invention proposes using SA (Server Agent) that functions as a trusted proxy (authentication without encryption) or terminates encrypted connections, performs optimization functions, and coordinates with OS (Origin Server) over a trusted transit network (for example using VPN). Alternatively, a CDN deployed in a central location such as in a GGSN/PGW location could dynamically activate an agent to offload or serve a set of websites based on need, for example during an event in stadium, it could activate SA in a capable transit NE closest to the stadium. This operation requires the following steps (assuming the OS knows the IP address of the transit NE that hosts the SA):
1. CSP transit NE or Network Analytics device determines increased traffic volume to a website and determines the edge NE that supports Server Agents. It notifies the Website of the availability of the Server Agent and address of transit NE and charging information for the service.
2. The website decides if it intends to use SA and communicates the IP addresses of servers (one or more servers at its site) to CSP notification.
3. CSP policy framework determines the target NE and environment in NE for creating SA for the domain (or activating the SA, if it was created and dormant in the NE), and determines reachability information of SA instance in the NE (IP Address, Port Number, etc.)
4. The CSP framework determines filtering rules and configures the rules in the NE via SDN Controller. The rules configure NE to direct flows to the Server IP addresses to the SA instance in the NE Application blade.
5. The server communicates information to decrypt information to process any encrypted packets to the SA. Thus, unlike a transparent Web-Proxy, the current invention proposes SA that is under a security framework & full control of the Origin Server.
6. The server agent starts functioning as a proxy caching server or a CDN server.
7. As the traffic decreases to the SA, or when the permitted time negotiated with the CSP expires the SA & OS co-ordinate to bypass SA.

While similar control-loop time reduction could be achieved with a CDN that terminates transport encryption (using shared certificate or TLS-SNI Extension), unlike the CDN methods, the proposed approach does not require content changes in the OS and is independent of specific CDN vendor methods; rather it proposes configuring the transit network to offload specific flows to SA opportunistically, similar to an inline proxy. Also, CDN platforms are deployed at dense data centers, whereas the SA could be deployed dynamically deeper in the CSP on capable NEs on a need basis. The approach can be extended by a CDN to extend its sub-functions to an edge NE on a need basis.

Origin Servers (OS) in coordination with CSP could instantiate or activate the SA function in a transit NE such as an Edge Router that services multiple access networks. If the transport protocol supports continuing user sessions across multiple access networks (for example QUIC), then SA could continue operations such as retransmission across multiple access networks. Locating SA functions in a transit NE has the advantage that it covers multiple base stations and thus accommodates mobility compared to locating optimization functions within a base station that covers a single cell or access network.

CSPs could offset the cost of migrating to SDN NEs by selling the capability to host site-specific SAs on a time, capacity, and usage basis. Alternatively, CSP could define specific types of SA functions such as Split-TCP, Content-Caching, etc., and charge on a capacity & usage basis.

### C. Hair-Pinning Services in Network Segments

In networked applications such as email, and messaging, clients communicate through a server that is accessible through the Internet. When internet connectivity is lost, even if two users are in the same network segment they could not communicate until the connection to the server is restored. SKYPE defined Super-Node that is used for short-circuiting data forwarding in network segments; for example, after presence detection via Server, two clients in a local network segment could communicate via the Super-Node. It also defines a Super-Node election by which multiple clients elect one of the capable clients as a Super-Node to perform forwarding functions between multiple clients. However, the Skype mechanism still uses a server connection for presence propagation and continued communication between clients. The current invention identifies using Server Agent (SA) that is created and managed by the server that caches portions of control information from a server (such as membership in local segments), and functions temporarily as a server when the internet connectivity is lost.

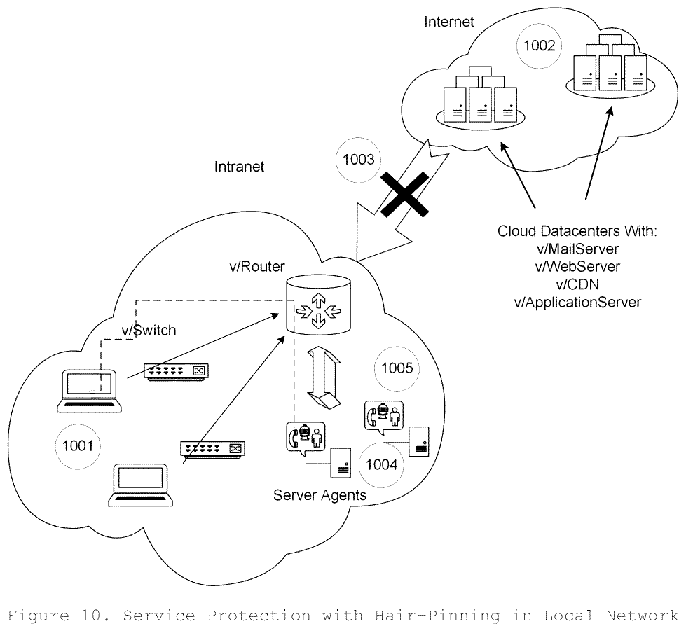

FIG. 10 depicts how hair-pinning that provides service protection may be deployed in a local network. Users 1001 wish to access services 1002. With ADNF, service agents 1004 are deployed at a location closer to the user. If the communications path 1003, to the service become unavailable server agents facilitate service continuation using hair-pinning. Hair-pinning 1005 implemented in a router local to the user intercepts the communications and directs the traffic to the service agents.

The hair-pinning function could be dynamically installed or configured at L2, L3, or up to the Application layer, for example, when two users are in the scope of the same WIFI AP, and exchanging a dense video using Facebook-APP, it would be nice if the WIFI-AP facilitates forwarding the video in a streaming fashion and forwards a copy to the Cloud Server for subsequent use. In the current environment, two users on the same WIFI-AP could exchange content directly, but not via FB-APP that is hosted in Cloud; they would have to use local applications in clients such as AIR-DROP, or explicit file transfers. If FB-Cloud Server could opportunistically create a server agent, and propagate the allowed user connectivity based on history, group membership, and the server agent in the AP could provide local transfer between the two clients transparently.

Following use-cases outline the types of virtual network functions that may be activated at network edges and their benefits using the ADNF methods identified in the current invention.

### D. Live Stream Replication & Retransmissions at the Edge

U.S. Pat. No. 8,111,630 B2, teaches methods of content caching in wireless mobile networks, and the associated benefits in reducing latencies and improving QOE. The server agent identified in the current invention facilitates opportunistically using split TCP/UDP for buffering the application data (TCP, UDP, QUIK etc.), from the internet server and transmitting on separate TCP/UDP connections to one or more clients for reducing control loops and increasing transport efficiency.

### E. Computing Function Close to Mobile Edges

The server agent could be dynamically instantiated in Network Elements at edges, such as transit routers, transit switches, or at Datacenters; the instantiation & activation of the function could be different for different network segments and could be based on the network traffic conditions. In mobile networks, locating Server Agent close to Base Station (eNB in LTE) requires session handovers between server agents for mobile users (vehicular mobility); locating the SA close to the core increases path lengths and decreases efficiency. However, in flash-mob or stadium event scenarios, efficiency could be improved significantly by moving SA closer to the edge. Thus, the server agent (or application proxy) that could be dynamically activated based on traffic usage optimizes the transport network use.

### F. Opportunistic Prefetching and Data Offload

The 5G RAN uses a significantly higher frequency band to increase network capacity; however, it reduces coverage area; thus, 5G standards incorporate using dual radio (5G RAN & LTE) with seamless handover between the two technologies. Video downloads from sites such as YouTube use progressive download and pacing to spread network usage close to the user's view time to minimize wasting resources if the user migrates away to another video clip. The pacing or access of small objects is less efficient than bulk fetches particularly in highspeed networks. Thus, opportunistically controlling pacing burst volumes, bundling website object fetches, and prefetching when a user is close to 5G or other High-Capacity Access points, such as in Airports, significantly increases network efficiency by speeding up data delivery close to high-capacity networks.

### G. Signaling & Service Offload in Dense Locations

As mobile user density increases during flash-mob, or stadium events, control path connections to control server (MME in LTE) significantly increase thus over loading and transit network paths to the control server. Overloading the control server increases response times and reduces QOE not only to users at the dense user event but also to all the users of that control server.

At such a dense user event many users tend to communicate among themselves, call or message origination & termination in the same stadium or nearby location. Thus, dynamically instantiating or activating virtual server (or server agent) using the outlined ADNF methods identified significantly improve QOE.

Additionally the current invention identifies the need for security validation, of a device while being connected to an intelligent system such as a computer, mobile phone, ipad, etc., to ensure, a) the device is authorized or allowed to be connected to the system per the security or authorization policies of the system, and b) the system that device is connecting to meets the security/authorization policies required by the device and/or device contents. When a device such as USB Storage device is connected, the file system of the device mounts the device so that system users can access the device through the file system APIs such as creating directories, creating files, read/write/modify/delete files that the file system provides. To this goal, the current invention identifies storing policies required for both (a) and (b) in the device in a Read Only or Write Once Read Multiple (WORM) or protected areas with additional write/modify validation mechanisms. Similarly, the system that the device connects to need to maintain what devices (for example, devices from specific vendors, specific file-system types & versions, specific users, and validation methods are essential. The validation methods may include but not limited to digital certificates, multi-factor authentication methods such as OTP (One Time Password) via user phone number, email-id, other user credential verification methods. While such validation methods are known in prior art and out of the scope of the current invention, the current invention defines methods of incorporating and invoking them while connecting removable devices to the system. The invention methods also identify using the methods with built in devices such as storage device in integrated systems such as laptops. The current invention teaches while mounting the device, the file system driver read the required validation methods, perform the said validation before mounting the device and making the files available to the system users. The portions stored in device ROM/WORM etc., may include application functions that are loaded into the system and executed by the system processing unit for maximum flexibility. Similarly, the methods or functions that need to be performed before the device is allowed to be part the file system or part of the Vapornet network of end devices. Such methods could be contained in a Virtual Container that runs on the top of a Client OS on a VM or on Client OS of the system. While the containers including methods for specific application uses are well known, the current invention identifies using security and validation methods and methods of using them during plugging in of removable devices, and the device being plugged in contains and orchestrates such methods. The methods in the device could be installed or written by the device manufacturer, reseller or enterprise IT department or by user or administrator with special privileges. For example, an enterprise with high security needs, when it purchases removable devices, the manufacturer programs the security requirements outlined above as (a) and (b), thus making sure the device is mountable only by the specific enterprise and/or specific departments or users, and the necessary contact numbers, credentials etc., for verification or attestation. The invention methods could be further extended to different portions or segments of the device (e.g., SSD or Hard Disk) such as device partitions, directories, or for each file. To this goal, the partition headers, file-system headers, directory headers need to be extended to include the required validation methods, and associated attributes such organization for department as information, and contact methods for validation, or user's phone number, email-id, biometrics etc.

The following steps outlines the methods identified in the current invention using connecting a USB storage device to a user's laptop as an example.
(1) Functions that are necessary for device validation or system validation are stored in the device in the fixed portion (ROM), or WORM (write once read multiple) portion of the device. They may point to other areas in the devices that are protected, so as to facilitate upgrades to functions.
(2) Device Validation attributes, such as device vendor, manufacturing location etc., CRC or method of computing checksum of the device to ascertain the device state, and methods & contact points for attestation. The authentication methods may include digital certificates.
(3) Similar to device validation, system validation methods and attributes are also installed in the device.
(4) When an organization procures the device, the device manufacturer or reseller or enterprise procurement commissioning department, or user installs validation attributes such as contact number or email address that need to be contacted for verifying the user that is connecting the device to the USB port, and verifying the system that it is being connected to. Thus, if the device is assigned to an employee or user, his contact number, email address, name, location, department name, other demographics such as secret questions are installed in the device. These serve to validate only authorized user is connecting the device to the USB port. Similarly authorized system information for devices such laptop, for desktop, company name, department name, administrator information, OS, Application name etc., that is allowed to connect the device are installed.
(5) After the device validation and the device is connected to the system, the device may need to be formatted if it is not already formatted, or the file system on the device need be mounted. The file system access, Read, Write, Modify, Delete, etc., functions that may be allowed, need to be installed or validated. Such attributes would dictate which users or departments could access, and validation methods when plurality of users access the file system.
(6) For verifying a user when he plugs in the device to USB, for example, using One Time Password (OTP), the system needs to generate OTP and send to the prior stored contact information of the specific user, and the user after receiving OTP, need to enter the OTP to the system as well known in the prior-art OTP/MFA methods. The current invention identifies the methods of incorporating the required methods and attributes to facilitate such validation. The device may be a simple device with controller or CPU system to generate and verify OTP or other attributes. In such a case the device contains function or algorithm code stored in the device, and the physical or virtual system that it is connecting to extracts (reads) from the device and executes the functions. If the device includes a controller or processing system such as a HD/SSD with controller logic, the processing system will perform the validation.

An additional embodiment of the current invention is validation of the system, department, or organization that the device is being connected to. For example, the device may contain highly classified or personal information of a high-profile user, and only certain systems, departments or business are allowed to connect the device to their system and access the contents. The department or business, for example, a bank may be managed by plurality of employees. The OTP or user-oriented methods require prior established phone number or email address of an employee, and a different employee need to contact the customer or the employee or may be changed. For example, when a customer calls a bank, the bank has customer email or phone number for sending OTP to the customer for verification. It is important to note that such verification uses 2 independent communication channels-one that the customer calls the bank phone number which is answered by one of the employees, and the other when the employee that answers the call uses prior stored contact information (for example while opening the account) for sending system generated OTP. However, if a bank employee (customer service) calls a customer, the customer does not have a method to verify that the caller is authorized employee of the bank with credentials to access his account, since if the customer calls the bank, since the communication channel is independent (bank number used by many employees using PBX. To this goal the current invention identifies the organization using a specialized client application in the user device that stores unique identifier that associates context for the user, and a department server contact reference (such as URL) that facilitates customer generating OTP or other identifier and sending to the organization server. The server determines which employee or customer service agent is making the call and routes the user generated OTP to the specific agent. The agent tells the code to the customer so that he could validate be assured that the caller is an authorized agent.

### SUMMARY OF BENEFITS

The present invention offers the ability to dynamically distribute resource sharing in a network cloud. This allows the following benefits compared to prior art. A typical Saas that public clouds provide is storage and file management services. Google Drive, Microsoft One Drive, and iCloud are examples of such services. These services are all designed to store and manage the content in the cloud by the cloud service provider. To access this content, an edge device must be connected to the Internet. The security of the content is limited by the trust in the cloud provider and intrusion by government entities. By distributing the content among the edge devices, the content remains in the control of the user. Thus, a Vapornet can assure a greater level of security and availability over traditional network clouds.

Since the content is distributed among edge devices, the amount of storage required inside the cloud is minimized. Therefore, the capacity of a Vapornet is significantly greater than that of a public cloud. Since storage and other resource use in cloud is reduced significantly by storing in user's edge devices, the service cost from cloud reduces significantly. If a small or medium enterprise offers services using Vapornet, locating storage & resources at the edge reduces the need for maintaining high resources in cloud when user volume decreases. A user may establish multiple sessions at the same time, each with different physical resources declared. This allows for the replication of resources across edge devices.

The virtual to physical mapping of resources within a Vapornet with the assistance of the directory service allows resources to be disconnected and reconnected at different locations. This provides for added resiliency and characterizes the mobile nature of the Vapornet.

What is claimed is:

1. System and methods of designing a virtual network (Vapornet) among multiple physical or virtual devices of a user or plurality of users such as a family, group of users, enterprise over the underlying plurality of physical and/or virtual network infrastructures that include but not limited to software defined networks, cloud networks, enterprise networks, home networks, internet backbone to facilitate adaptive & dynamic access to resources by,
provisioning users with resources that they can access,
provisioning users with resources that they can provide to others,
identifying resources in a global namespace independent of their physical location,
mapping resource identifiers from the global namespace to physical locations relative to the user,
and providing seamless access to resources in the available virtual network segments using the global name space.

2. The Vapornet design of claim 1 wherein the connectivity to some of the resources may not be available, for example, due to the loss of internet/cloud connectivity, and users could access the resources using the same global namespace in the network segment they could connect to and the vapornet maps to one or more of the best resources that are reachable.

3. The said virtual devices in claim 1 may be shared devices that service providers provide that include but not limited to Cloud, SDN, enterprise, application, and network service providers that offer layered software devices over physical devices to multiple users or organizations.

4. The Vapornet design of claim 1 wherein the resources provided by a user may declare the availability or unavailability of a resource at any time and may dynamically move resources to different physical locations and/or alternative networks without user intervention based on the performance or availability of the underlying network.

5. The Vapornet design of claim 1 uses directory service to map the global namespace to physical and/or virtual namespaces in plurality of transit networks.

6. The said directory service in claim 5 may be replicated and migrated around the transit networks that include but not limited to Internet Backbone to increase availability and performance.

7. Methods of dynamically and opportunistically instantiating and/or activating already installed network functions in capable transit and edge network elements of plurality of service providers & edge networks to reduce round trip delays, latency, improve throughput & quality of experience and monetization for service providers.

8. The method of installing network functions in capable devices in claim 7 includes a transit device including its capability of supporting such proxy functions, based on its resources that include, but not limited to processing power, memory, storage, network connectivity that it could provide for such functions while forwarding client requests such as DNS requests to the server.

9. The said network functions in claim 7 include hair-pinning/bridging functions at L2/L3 & application layers, virtualized server/proxy agent that is controlled by end-systems such as client devices, application proxy, TCP proxy, content caches, web servers, and content publishers based on service needs & service availability at specific location, traffic density, network connectivity/outage, and monetization for service providers.

10. The said instantiating and activating network functions in claim 7 includes, cross-layer control of network functions, and/or dynamic proxy/agent creation by upper layers (L3, L4 and above), based on attributes that include but not limited to application type, content type, service type, application throughput and latency requirements.

11. The method of activating network functions in claim 7 includes automatically turning on WIFI-Hotspot function in a mobile device in a home or known WIFI network when the WIFI Access point in the corresponding WIFI network or the mobile device detects the uplink internet connection is down or performance/throughput severely degraded so as to facilitate uplink path to other devices in the known WIFI network.

12. The method of facilitating uplink internet path to other devices in the known WIFI network in claim 11 includes, turning off the specific SSDN with down or degraded internet uplink, so that other devices detect loss of WIFI signal and switch to an alternate WIFI network or SSDN of the mobile-WIFI hotspot.

13. The method of facilitating uplink internet path to other devices in claim 11 includes, configuring the WIFI access point with degraded or down uplink path to use mobile-WIFI hotspot as uplink internet path, so that other devices continue to use the WIFI access point.

14. The methods of turning on WIFI Hotspot function in claim 11 includes, the WIFI access point and the mobile device monitoring the uplink network path in the access point and switching back to the uplink internet connection in the access point to use the best uplink path and automatically turning off WIFI hotspot function in the mobile device.

15. The methods of facilitating uplink internet path to other devices in claim 11 includes, the access point or mobile device configuring the device to use mobile WIFI hotspot as alternative WIFI network.

16. Method of including and/or installing server/proxy agent in client, and/or physical/virtual network devices based on device capabilities and opportunistically activating the server agent to function as server when connection to remote server is lost to facilitate proxy & resource sharing & hair-pinning functions among the user devices based on the network connectivity available to the set of user devices at that time in that location.

17. The set of server/proxy agents in claim 16 include installing a proxy virtual Mobility Management Entities (MME in 4G, AMF in 5G) in a transit multi-service platform in a wireless mobile network to reduce network and signaling congestion in heavy mobile network usage.

18. The method of activating server agent to function as server in claim 16 includes, selecting most capable server agent & device based on its memory, computing power, storage, and network connectivity.

19. The server agent acting as server in claim 18 includes, the server agent maintaining data changes, perform caching/proxy functions and subsequently communicating with the actual server when the connectivity is restored, performing hair-pinning functions to facilitate connectivity between users and devices in the remaining network when the connectivity to the server is lost.

20. The said facilitating connectivity in the remaining network in claim 19 includes, the server agent forwarding mail or messages between users in the remaining network while acting as mail or message server and syncing up with the real server after connectivity is restored.
